(19) United States
(12) Patent Application Publication
(10) Pub. No.: US 2010/0119318 A1
(43) Pub. Date: May 13, 2010

(54) Machine Tool Apparatus and Related Methods

(76) Inventor: Dennis Kim Morris, Wildwood, FL (US)

Correspondence Address: JACQUELINE E. HARTT, PH. D.;LOWNDES DROSDICK DOSTER KANTOR & REED, P.A., P.O. BOX 2809, ORLANDO, FL, 32802-2809, US

(21) Appl. No.: 12/594,404

(22) PCT Filed: Apr. 4, 2008
(86) PCT No.: PCT/US08/04382

§ 371 Date: Oct. 2, 2009

Related U.S. Application Data
(60) Provisional application No. 60/909,963, filed on Apr. 4, 2007.

(51) Int. Cl. B23C 7/00; B23C 3/00

(52) U.S. Cl. 409/132; 409/143; 409/144

(57) ABSTRACT

A machine tool apparatus includes a transfer arm assembly and a carriage assembly. The transfer arm assembly includes a housing with a tooling end adapted to carry a tooling bit extending therefrom, a spindle extending from the housing for engagement by a chuck, and at least a first drive shaft for transferring rotational motion from the spindle to the tooling end. The tooling end is adapted to carry the tooling bit for rotation about a tooling axis that is angularly offset from a rotational axis of the first drive shaft. The carriage assembly carries the transfer arm assembly and is adapted to allow translation of the transfer arm assembly in at least two directions.

### CROSS REFERENCE TO RELATED APPLICATION(S)

This application claims the benefit of U.S. Provisional Application Ser. No. 60/909,963, filed on Apr. 4, 2007, the contents of which are hereby incorporated by reference in their entirety.

### FIELD OF THE INVENTION

The present invention generally relates to machine tools, and more particularly, to a machine tool apparatus for use in connection with milling machines.

### BACKGROUND OF THE INVENTION

Machining internal features, such as internal keyways, in workpieces is often a difficult and time-consuming process, requiring frequent, and often complex, adjustments to workpieces and to the machine tool or tools employed to machine the features.

U.S. Pat. No. 2,475,227 and U.S. Pat. No. 4,923,342 describe various devices intended to facilitate the machining of internal features. However, these devices employ circular cutting blades that are limited in their ability to create specialized features. For instance, forming features with varying depths typically requires one or more blade changes and it can be difficult or impossible to create certain features that do not begin at an edge of the workpiece. Also, the cutting action of the circular blades tends to set up undesirable stresses in the workpiece around the machined feature.

U.S. Pat. No. 8,24,322 and U.S. Pat. No. 2,372,913 describe devices in which tooling bits are used instead of circular cutting blades. While the use of tooling bits tends to result in lower stresses in the workpiece, the devices of the '322 and '913 patents are also somewhat limited in the types of features that can be created. For instance, cutting keyways with varying depths, while not necessarily requiring a change of tooling, requires stopping to adjust the position of the workpiece or the tooling, increasing the time required and limiting the complexity of depth variations that are practically achievable.

Additionally, none of the devices in the above patents is adapted to take advantage of the capabilities of modern milling machines, which feature chucks having multiple translational and rotational degrees of freedom. For instance, these devices would lack the dimensional stability to reliably machine features when moved in multiple directions.

Forming keyways or similar features is often a part of larger milling or machining jobs. Due to the time and difficulty of forming keyways, many machine shops will turn away such jobs even though they can complete the non-keyway related aspects of the job relatively easily.

### SUMMARY OF THE INVENTION

In view of the foregoing, it is an object of the present invention to provide a machine tool apparatus that enables complex keyways and other features to be formed more quickly and reliably. It is a further object of the present invention to provide a machine tool apparatus that is adapted utilize the capabilities of modern milling machines and other machine tools to form keyways as well as a range of additional features.

According to an embodiment of the present invention, a machine tool apparatus includes a transfer arm assembly and a carriage assembly. The transfer arm assembly includes a housing with a tooling end adapted to carry a tooling bit extending therefrom, a spindle extending from the housing for engagement by a chuck, and at least a first drive shaft for transferring rotational motion from the spindle to the tooling end. The tooling end is adapted to carry the tooling bit for rotation about a tooling axis that is angularly offset from a rotational axis of the first drive shaft. The carriage assembly carries the transfer arm assembly and is adapted to allow translation of the transfer arm assembly in at least two directions.

According to an aspect of the present invention, a tooling end adapter includes an adapter housing and an adapter rotation transfer mechanism arranged therein. The adapter has an adapter tooling end adapted to carry an adapter tooling bit extending therefrom and a tooling engagement end adapted to engage the tooling end of the transfer arm assembly housing. The adapter rotation transfer mechanism transfers rotational motion from the tooling engagement end to the adapter tooling end.

According to another aspect of the present invention, a method of machining a feature into a workpiece includes arranging a machine tool apparatus on a milling machine bed. The machine tool apparatus includes a transfer arm assembly carried by a carriage assembly allowing translation in at least two directions. The transfer arm assembly has substantially perpendicular first and second drive shafts for transferring rotational motion from a spindle to a tooling end. A tooling bit is inserted into the tooling end, and the spindle is engaged with a milling machine chuck. The workpiece is secured adjacent to the tooling end with a workpiece holding section. The milling machine chuck is rotated to rotate the tooling bit, and the milling machine chuck is moved to move the tooling bit into engagement with the workpiece.

These and other objects, aspects and advantages of the present invention will be better understood in view of the drawings and the following detailed description of a preferred embodiment.

### BRIEF DESCRIPTION OF THE DRAWINGS

FIG. 1 is a schematic perspective view of a machine tool apparatus, including a workpiece holding section and a power transmission section, according to an embodiment of the present invention;

FIG. 2 is a side view of the workpiece holding section of FIG. 1, with components partially cut-away to show details and hidden components shown in broken lines;

FIG. 3 is a front view of the power transmission section of FIG. 1, including a transfer arm assembly housing formed from connected housing halves;

FIG. 4 is a side view of the power transmission section of FIG. 1;

FIG. 5 is a side view of one of the housing halves of FIG. 3, showing internal details of the transfer arm assembly;

FIG. 6 is a perspective view of a workpiece with examples of features machinable with the machine tool apparatus of FIG. 1;

FIG. 7 is side view of a tooling end adapter, according to an aspect of the present invention, connected to the transfer arm assembly of the power transmission section of FIG. 1, with hidden components shown in broken lines; and

FIG. 8 is partially exploded, schematic perspective view of the tooling end adapter of FIG. 7.

### DETAILED DESCRIPTION OF A PREFERRED EMBODIMENT

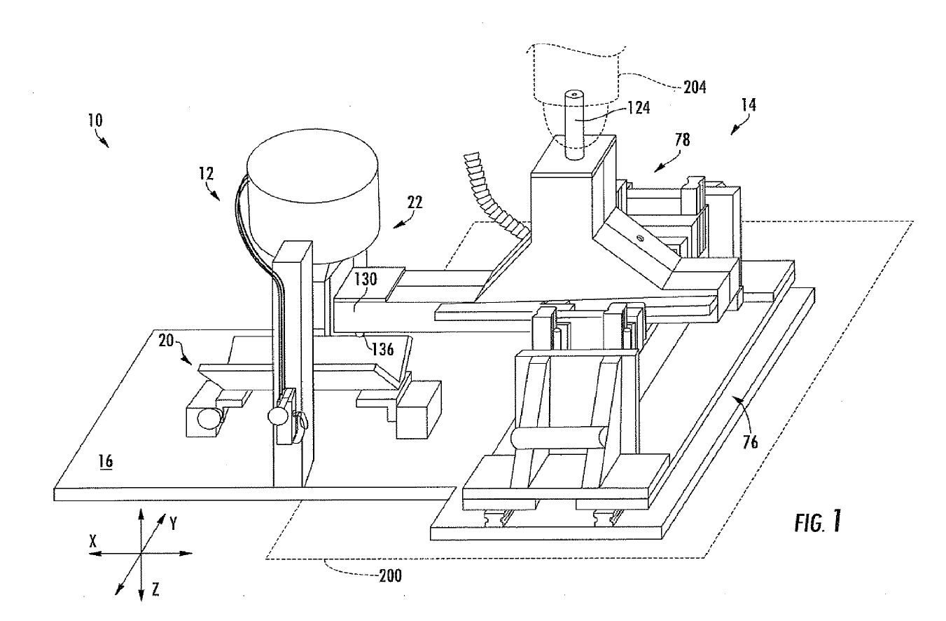

Referring to FIG. 1, according to an embodiment of the present invention, a machine tool apparatus 10 includes a workpiece holding section 12 and a power transfer section 14. The apparatus 10 further includes a base plate 16 on which the holding section 12 and power transmission section 14 are mounted. References herein to the x-, y-, and z-directions are made relative to the coordinate indications on the Figures.

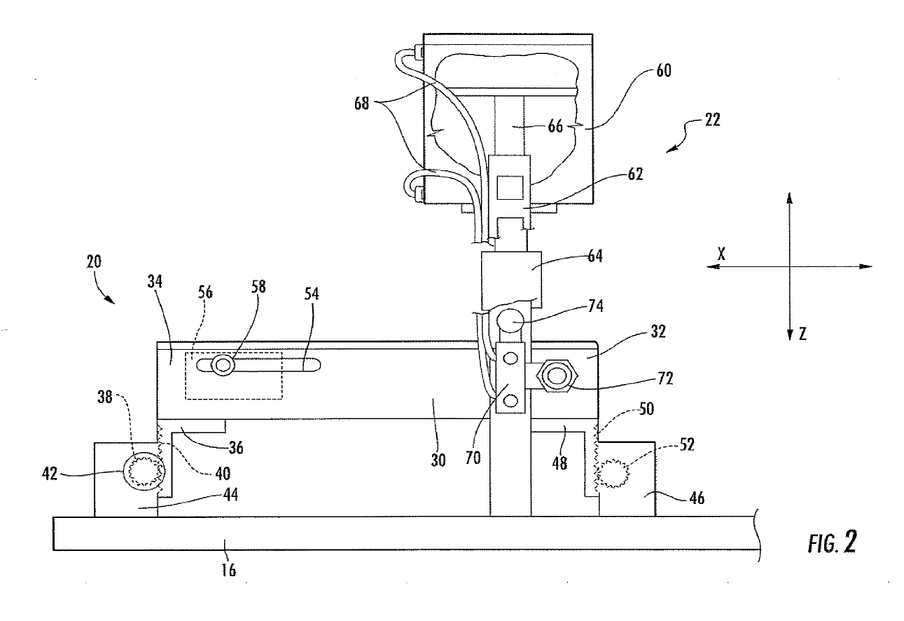

Referring to FIG. 2, the workpiece holding section 12 has a stage assembly 20 and a pneumatic clamp assembly 22. The stage assembly 20 has a v-shaped stage 30 with a first end 32 extending through the pneumatic clamp assembly 22. A second end 34 of the stage 30 is connected with a z-adjustment plate 36. A pinion 38 engages a corresponding rack 40 on the plate 36. A z-adjustment knob 42 is connected coaxially with the pinion 38. The pinion 38 and knob 42 are rotatably mounted in a block 44 secured to the base plate 16. For additional stability, the first end 32 of the stage 30 is moveably engaged to another block 46 by plate 48, rack 50 and pinion 52.

The stage 30 has a slot 54 defined therein. A stopper block 56 is connected with the v-shaped stage 30 by a stopper block adjustment knob 58. The adjustment knob 58 extends through a portion of the slot 54 and is adjustably threaded into the stopper block 56.

The pneumatic clamp assembly 22 includes a pneumatic cylinder 60 suspended over the first end 32 of the v-shaped stage 30. The cylinder 60 is connected to a frame 62 secured to the base plate 16. A clamp 64 is connected to a piston rod 66 extending into the cylinder 60. Pneumatic lines 68 extend between the cylinder 60 and a pneumatic control valve 70 connected to the frame 62. An air inlet 72 extends from the valve 70 opposite the pneumatic lines 68 allowing an air supply line (not shown) to be connected with the pneumatic clamp assembly 22. A control handle 74 is connected to the control valve 70.

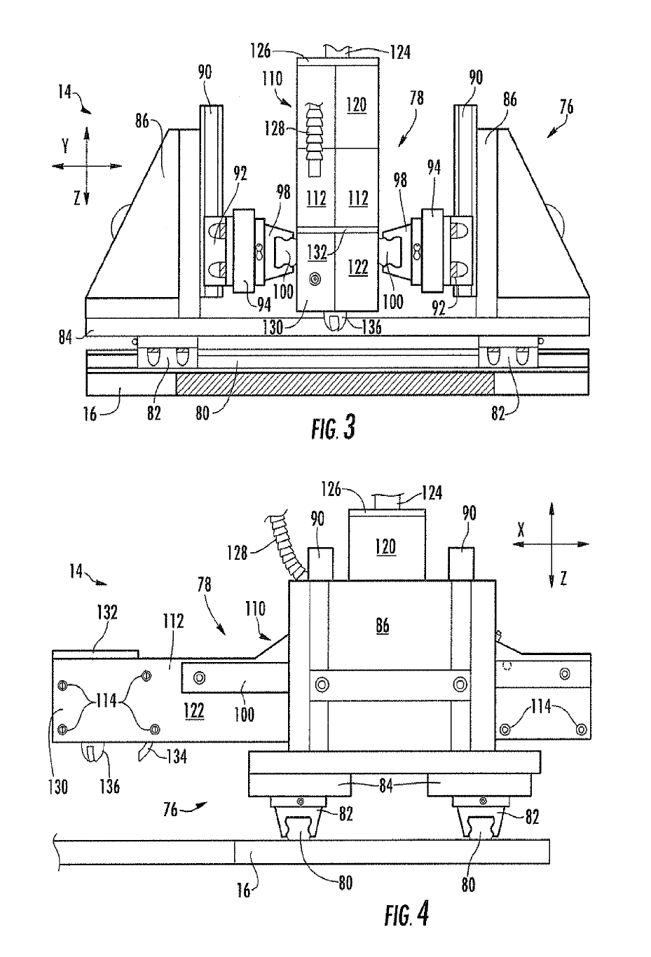

Referring to FIGS. 3 and 4, the power transfer section 14 includes an xyz carriage assembly 76 carrying a transfer arm assembly 78. The carriage assembly 76 has y-oriented rails 80 secured to the base plate 16. Y-oriented linear bearings 82 slidably engage the y-oriented rails 80. Cross bars 84 overlie the y-oriented rails 80 and are secured to the y-oriented linear bearings 82.

Carriage sidewalls 86 are secured to opposite ends of the cross bars 84 and extend therefrom in the z-direction away from the base plate 16. Z-oriented rails 90 are connected to the sidewalls 86 facing toward the transfer arm assembly 78. Z-oriented linear bearings 92 slidably engage the z-oriented rails 90. The z-oriented linear bearings 92 are secured to side bars 94. X-oriented linear bearings 98 are also secured to the side bars 94 and slidably engage x-oriented rails 100 connected to the transfer arm assembly 78.

The transfer arm assembly 78 includes a housing 110 formed of housing halves 112. The housing halves 112 are secured together by a plurality of machine screws 114. The housing 112 includes a z-oriented portion 120 and a x-oriented portion 122 that meet to form a “T”. A spindle 124 extends from the z-oriented portion 120 through a first cover plate 126, and a fluid connection line 128 enters the housing 110 in the z-oriented portion 120. Proximate to the stage assembly 20 (see FIG. 1), the x-oriented portion 122 has a tooling end 130 covered by a second cover plate 132. A fluid outlet 134 and a tooling bit 136 extend out of the tooling end 130.

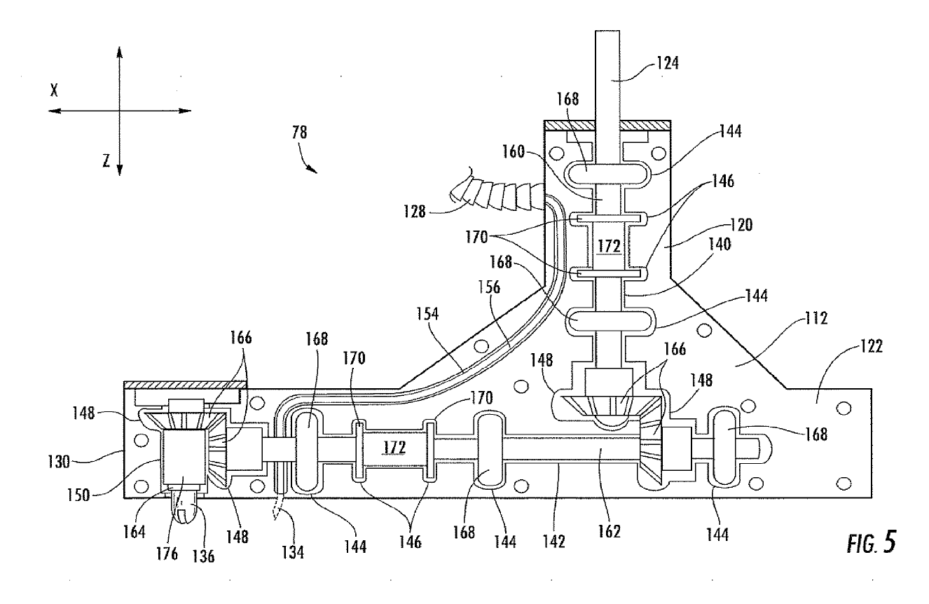

Referring to FIG. 5, complementary halves of a z-oriented bore 140 and x-oriented bore 142 are defined in the housing halves 112, so as to extend through respective z- and x-oriented portions 120, 122 of the housing 110 when the housing halves 112 are assembled. The bores 140, 142 are formed with a plurality of roller bearing seats 144 and thrust bearing seats 146, as well as gear clearances 148. Additionally, complementary halves of a tooling bore 150 are defined in the housing halves 112 at the tooling end 130 of the x-oriented portion 122.

A cooling fluid channel 154 is formed in one of the housing halves 112 extending between the fluid connection line 128 and the fluid outlet 134. The cooling fluid channel 154 is dimensioned to receive a cooling fluid tube 156 therein, with one end attached to the fluid connection line 128 and the other end forming and terminating at the cooling fluid outlet 134.

The transfer arm assembly 78 further includes a z-oriented drive shaft 160, x-oriented drive shaft 162 and tooling holder 164 accommodated within the z-oriented bore 140, x-oriented bore 142 and tooling bore 150, respectively. The spindle 124 forms an upper end of the z-oriented drive shaft and the tooling bit 136 is removably inserted into the tooling holder 164.

Bevel gears 166, accommodated within the gear clearances 148, transfer power between the z-oriented drive shaft 160 and the x-oriented drive shaft 162, and between the x-oriented drive shaft 162 and the tooling holder 164. A plurality of roller bearings 168 are arranged around the z- and x-oriented drive shafts 160, 162 and seat within the roller bearing seats 144. A plurality of thrust bearings 170 are arranged around the z- and x-oriented drive shafts 160, 162 and seat within the thrust bearing seats 146. Between each pair of thrust bearings 170, there are respective increased diameter portions 172 of the z- and x-oriented drive shafts 160, 162. A bearing element 176, preferably an oil-impregnated bushing, needle bearing or the like, is arranged around the tooling holder 164 and seats within the tooling bore 150.

In operation, the machine tool apparatus 10 is arranged on a milling machine bed 200 (see FIG. 1) or other suitable surface. The chuck 204 of the milling machine is attached to the spindle 124 of the transfer arm assembly 78. An air supply line is connected to the air inlet 72 and the fluid connection line 128 is connected to a fluid supply. An appropriate tooling bit 136 is inserted into the tooling holder 164.

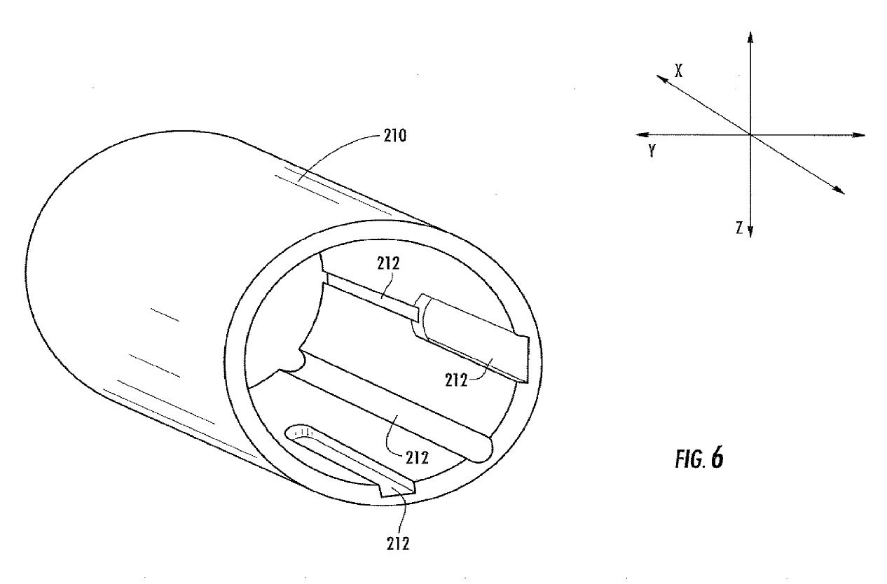

A workpiece 210 (see, for example, FIG. 6) to be keyed is arranged on the stage 30 and butted against the stopper block 56 (see FIG. 2). The stopper block 56 and workpiece 210 are slid into the desired position and the stopper block 56 is set by tightening the stopper block adjustment knob 58. Final z-adjustments are made to the workpiece 210 by operating the z-adjustment knob 42 to raise or lower the stage 30. The control handle 70 is operated to port air through the pneumatic lines 68 to the top of, and from the bottom of, the pneumatic cylinder 60, displacing the piston rod 66 toward the workpiece 210. The clamp 64 engages the workpiece 210, holding the workpiece 210 immobile.

The milling machine chuck 204 is rotated and this rotation is transferred through the transfer arm assembly 78 to the tooling holder 164 by the z- and x-oriented drive shafts 160, 162, causing the tooling bit 136 to rotate. The milling machine chuck 204 is translated is the desired direction or directions to move the transfer arm assembly 78 and engage the tooling bit 136 with the workpiece 210 for the feature 212 to be machined. Examples of features 212 that are quickly and easily machined using the machine tool apparatus 10 are shown in FIG. 6.

From the foregoing, it will be appreciated that the machine tool apparatus of the present invention advantageously allows the chuck movement capabilities of modern manual and computer numerical control milling to more quickly and reliably machine a variety of features including, for example, internal and external keyways, splines, gears, blind holes, oil ring grooves, tapered keyways and step keys. For instance, keyways and other features having a variable or step change in depth in the z-direction can be machined without having to reset or adjust the workpiece.

Additionally, the carriage assembly 76 enhances the directional stability of the transfer arm assembly 78 during movement and machining. For additional directional stability, the x-, y- and z-oriented rails 80, 90 of the xyz carriage assembly 76 can be equipped with locking mechanisms, for instance, computer controlled electromagnetic locks. Prior to commencing, or alternately during, keying, one or more locking mechanisms can be locked.

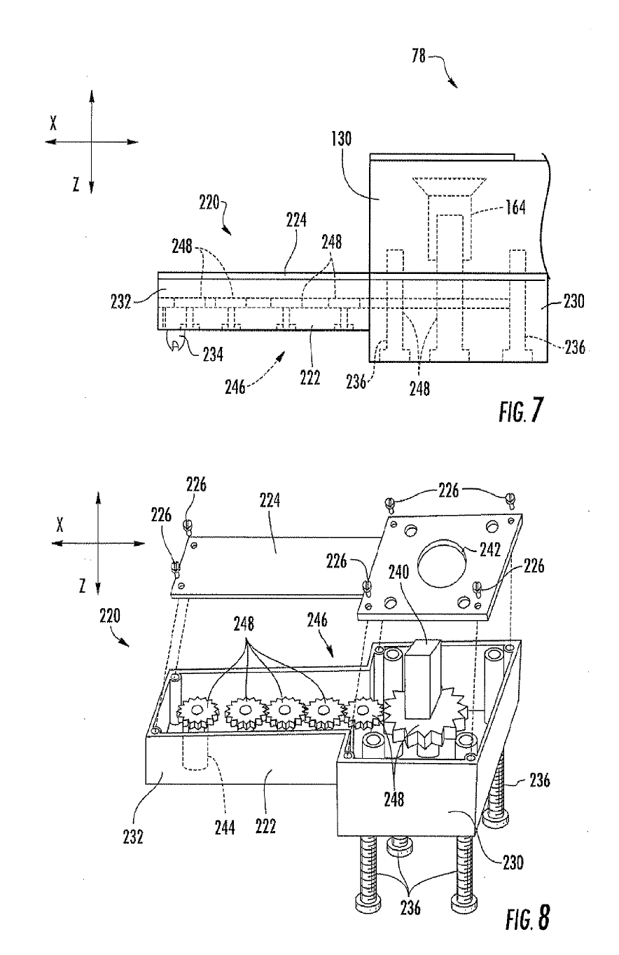

Referring to FIGS. 7 and 8, according to an aspect of the present invention, a tooling end adapter 220 is connected to the tooling end of the transfer arm assembly 78 in lieu of a tooling bit. The tooling end adapter 220 includes a housing 222 having a cover 224. The cover 224 is secured to the housing 222 by a plurality of screws 226.

The housing 222 extends between a tooling engagement end 230, adapted to engage the tooling end 130 of the transfer arm assembly 78, and an adapter tooling end 232, adapted to rotatably carry an adapter tooling bit 234. The tooling engagement end 230 is secured to the tooling end 130 by a plurality of screws 236.

The tooling engagement end 230 includes a rotatably mounted bit adapter 240 for engagement with the tooling holder 164 of the tooling end 130. The bit adapter 240 extends through an opening 242 in the cover 224. The adapter tooling end 232 includes a rotatably mounted adapter tooling holder 244 for holding the adapter tooling bit 234.

An adapter rotation transfer mechanism 246 extends between the tooling engagement end 230 and the adapter tooling end 232 for transferring rotational motion therebetween. The adapter rotation transfer mechanism 246 includes a plurality of intermeshing rotatably mounted gear wheels 248.

The dimensions of adapter tooling end 232 in a plane orthogonal to the x-direction are smaller than the dimensions of the tooling end 130 of the transfer arm assembly. As a result, the tooling end adapter 220 adds flexibility to the apparatus 10 by, for example, allowing internal machining of workpieces with internal clearances insufficient to permit the introduction of the tooling end 130.

Those skilled in the art will appreciate that the present invention is not limited to the embodiment herein shown and described. Instead, various modifications, and adaptations for particular circumstances, are possible within the scope of the invention as herein shown and described.

For example, in the embodiment shown, the power transfer section 14 is adapted for compatibility with a vertically-oriented milling machine. However, aspects of the present invention are readily applicable or adaptable for use in connection with horizontally-oriented milling machines and other machine tools capable of engaging a spline and impart rotation motion thereto. For instance, in connection with a horizontally-oriented milling machine, a straight transfer arm assembly with a single drive shaft terminating in a spindle could be employed, rather than the t-shaped transfer arm 78 with dual drive shafts 160, 162.

Spindle, as used herein, is not necessarily limited to a rod- or pin-shaped structure, but should be understood to encompass equivalent structures that are engageable by a chuck to impart rotational motion. Similarly, chuck, as used herein, is not necessarily limited to a particular structure, but should be understood to encompass portions of machine tools adapted for engaging other structures to impart rotation thereto. Additionally, while the term machine tool is not necessarily limited to machines designed for working particular materials.

Also, the power transmission section 14 can be used in combination with other workpiece holding section, either commonly or separately mounted. For instance, a fixed stage could be employed. As another example, a mechanical vice, hydraulic or electromagnetic clamp could be used instead of the pneumatic clamp assembly 22.

Additionally, although a carriage assembly employing linear bearings and rails have been found to present excellent stability, carriage assemblies employing other mechanisms for supporting relative motion between components, such as other bearing types, could also be employed. Carriage assemblies can also be employed adapted to accommodate other degrees of freedom impartable by machine tools to chucks.

Furthermore, adapter rotation transfer mechanisms employing elements other than, or in addition to the plurality of gears 248 are possible within the scope of the present invention. For example, belts, chains or drive shafts could also be employed in connection with a rotation transfer mechanism.

The foregoing examples are not an exhaustive list of possible modifications and adaptations. Rather, those skilled in the art will understand that these and other modifications and variations fall within the scope of the present invention as herein shown and described.

What is claimed is:

1. A machine tool apparatus comprising:
a transfer arm assembly including;
a housing with a tooling end adapted to carry a tooling bit extending therefrom for rotation about a tooling axis;
a spindle extending from the housing for engagement by a chuck; and
at least a first drive shaft for transferring rotational motion from the spindle to the tooling end, the first drive shaft rotatable about a first axis, the tooling and first axes angularly offset; and
a carriage assembly carrying the transfer arm assembly and adapted to allow translation of the transfer arm assembly in at least two directions.

2. The apparatus of claim 1, wherein a tooling holder is arranged in the tooling end for carrying the tooling bit.

3. The apparatus of claim 1, wherein the housing includes a pair of housing halves and at least a first bore for the first drive shaft is defined between the housing halves.

4. The apparatus of claim 3, wherein the transfer arm assembly includes a plurality of bearings arranged around the first drive shaft, a plurality of bearing seats for the plurality of bearings being defined between the housing halves.

5. The apparatus of claim 4, wherein the plurality of bearings includes at least one thrust bearing and at least one roller bearing.

6. The apparatus of claim 1, wherein the transfer arm assembly further includes a second drive shaft for transferring rotational motion from the spindle to the tooling end, the first drive shaft rotatable about a second axis, the first and second axes angularly offset.

7. The apparatus of claim 6, wherein the spindle is an end of the second drive shaft.

8. The apparatus of claim 6, wherein at least two roller bearings are arranged around the first drive shaft and the second drive shaft engages the first drive shaft between the at least two roller bearings.

9. The apparatus of claim 6, wherein the tooling axis and the second axis are substantially parallel.

10. The apparatus of claim 9, wherein the tooling axis and the second axis are substantially perpendicular to the first axis.

11. The apparatus of claim 1, wherein the transfer arm assembly further includes a cooling fluid tube extending through a cooling fluid channel defined in the housing, the cooling fluid tube terminating at a cooling fluid outlet extending from the tooling end.

12. The apparatus of claim 1, wherein the carriage assembly is adapted to allow translation of the transfer arm assembly in three directions.

13. The apparatus of claim 1, wherein the carriage assembly includes a plurality of rails and a plurality of linear bearings slidably engaging the rails.

14. The apparatus of claim 1, further comprising a workpiece holding section adapted to secure a workpiece for engagement by the tooling end of the transfer arm assembly.

15. The apparatus of claim 14, wherein the workpiece holding section includes a stage assembly and a clamp assembly.

16. The apparatus of claim 14, wherein the stage assembly includes a stage translatable in a direction substantially parallel with the tooling axis.

17. The apparatus of claim 14, further comprising a base plate, the carriage assembly and the workpiece holding section being mounted on the base plate.

18. The apparatus of claim 1, further comprising a tooling end adapter including;
an adapter housing having an adapter tooling end adapted to carry an adapter tooling bit extending therefrom for rotation about an adapter tooling axis and a tooling engagement end adapted to engage the tooling end of the transfer arm assembly housing; and
an adapter rotation transfer mechanism arranged in the adapter housing to transfer rotational motion from the tooling engagement end to the adapter tooling end.

19. The apparatus of claim 18, wherein, orthogonal to the first axis, the dimensions of adapter tooling end are smaller than the dimensions of the tooling end of the transfer arm assembly housing.

20. A method of machining a feature into a workpiece, the method comprising steps of:
arranging a machine tool apparatus on a milling machine bed, the machine tool apparatus including a transfer arm assembly carried by a carriage assembly allowing translation in at least two directions, the transfer arm assembly having substantially perpendicular first and second drive shafts for transferring rotational motion from a spindle to a tooling end;
inserting a tooling bit into the tooling end;
engaging the spindle with a milling machine chuck;
securing a workpiece adjacent to the tooling end with a workpiece holding section;
rotating the milling machine chuck to rotate the tooling bit; and
translating the milling machine chuck to move the tooling bit into engagement with the workpiece.
